(19) United States
(12) Patent Application Publication
(10) Pub. No.: US 2019/0351716 A1
(43) Pub. Date: Nov. 21, 2019

(54) TIRE SIDEWALL FOR A HEAVY DUTY CIVIL ENGINEERING VEHICLE

(71) Applicant: COMPAGNIE GENERALE DES ETABLISSEMENTS MICHELIN, Clermont-Ferrand (FR)

(72) Inventors: CHRISTOPHE LEMARCHAND, Clermont-Ferrand (FR); THIERRY ROYER, Clermont-Ferrand (FR); CÉCILE BELIN, Clermont-Ferrand (FR); CÉCILE ROUSSEL, Clermont-Ferrand (FR)

(21) Appl. No.: 16/479,449

(22) PCT Filed: Dec. 1, 2017
(86) PCT No.: PCT/FR2017/053346

§ 371 Date: Jul. 19, 2019

(30) Foreign Application Priority Data
Jan. 20, 2017 (FR) 1750462

(51) Int. Cl. B60C 13/00; B60C 1/00

(52) U.S. Cl. CPC B60C 13/00; B60C 1/0025; B60C 2200/065; B60C 2013/006; B60C 2013/007

(57) ABSTRACT

A radial tire (10) for a heavy vehicle of construction plant type, and more particularly, to the sidewalls thereof (20), aims to reduce the surface cracking of the tire sidewalls and slow down the propagation of cracks in the thickness of the sidewall. The tire (10) comprises two sidewalls (20), each sidewall (20) consisting of a laminate comprising at least first and second sidewall layers (21, 22) that are axially superposed and have a total thickness E, the axially outermost first sidewall layer (21) having a thickness E1 and consisting of a elastomeric compound M1, the axially innermost second sidewall layer (22) having a thickness E2 and consisting of a second elastomeric compound M2. The thickness E1 is at most equal to 0.9 times the total thickness E, the thickness E2 is at least equal to the minimum value between 3 mm and 0.1 times the total thickness E, the first elastomer compound M1 has a number of cycles to failure NR1 at least equal to 150,000 cycles, the second elastomeric compound M2 has a number of cycles to failure NR2 at least equal to 300,000 cycles and the VP1/VP2 ratio of the respective crack propagation rates in the first and second elastomeric compounds (M1, M2) is at least equal to 1.25.

The present invention relates to a radial tyre intended to be fitted to a heavy vehicle of construction plant type, and more particularly to the sidewalls of such a tyre.

A radial tyre for a heavy vehicle of construction plant type is intended to be mounted on a rim, the diameter of which is at least equal to 25 inches, according to European Tyre and Rim Technical Organisation or ETRTO standard. It is usually fitted to a heavy vehicle, intended to bear high loads and to run on harsh terrain such as stone-covered tracks.

Generally, since a tyre has a geometry of revolution relative to an axis of rotation, its geometry is described in a meridian plane containing its axis of rotation. For a given meridian plane, the radial, axial and circumferential directions respectively denote the directions perpendicular to the axis of rotation, parallel to the axis of rotation and perpendicular to the meridian plane.

In the following text, the expressions “radially inner/radially on the inside” and “radially outer/radially on the outside” mean “closer to” and “further away from the axis of rotation of the tyre”, respectively. “Axially inside” and “axially outside” mean “closer to” and “further away from the equatorial plane of the tyre”, respectively, the equatorial plane of the tyre being the plane passing through the middle of the tread surface and perpendicular to the axis of rotation.

A tyre comprises a tread intended to come into contact with the ground, the two axial ends of which are connected via two sidewalls to two beads that provide the mechanical connection between the tyre and the rim on which it is intended to be mounted.

A radial tyre further comprises a reinforcement made up of a crown reinforcement radially on the inside of the tread and a carcass reinforcement radially on the inside of the crown reinforcement.

The crown reinforcement of a radial tyre comprises a superposition of circumferentially extending crown layers radially on the outside of the carcass reinforcement. Each crown layer is made up of generally metallic reinforcers that are mutually parallel and coated in a polymeric material of the elastomer or elastomeric compound type.

The carcass reinforcement of a radial tyre customarily comprises at least one carcass layer comprising generally metallic reinforcers that are coated in an elastomeric compound. A carcass layer comprises a main part that joins the two beads together and is generally wound, in each bead, from the inside of the tyre to the outside around a usually metallic circumferential reinforcing element known as a bead wire so as to form a turn-up. The metallic reinforcers of a carcass layer are substantially parallel to one another and form an angle of between 85° and 95° with the circumferential direction.

A tyre sidewall comprises at least one sidewall layer consisting of an elastomeric compound and extending axially towards the inside of the tyre from an outer face of the tyre, in contact with the atmospheric air. At least in the region of greater axial width of the tyre, the sidewall extends axially inwardly to an axially outermost carcass layer of the carcass reinforcement.

An elastomeric compound is understood to mean an elastomeric material obtained by blending its various constituents. An elastomeric compound conventionally comprises an elastomeric matrix comprising at least one diene elastomer of the natural or synthetic rubber type, at least one reinforcing filler of the carbon black type and/or of the silica type, a usually sulfur-based crosslinking system, and protective agents.

An elastomeric compound may be characterized mechanically, in particular after curing, by its dynamic properties, such as a dynamic shear modulus G*=(G′²±G″²)^{1/2}, wherein G′ is the elastic shear modulus and G″ is the viscous shear modulus, and a dynamic loss tgδ=G″/G′. The dynamic shear modulus G* and the dynamic loss tgδ are measured on a viscosity analyser of the Metravib VA4000 type according to standard ASTM D 5992-96. The response of a sample of vulcanized elastomeric compound in the form of a cylindrical test specimen with a thickness of 4 mm and a cross section of 400 mm², subjected to a simple alternating sinusoidal shear stress, at a frequency of 10 Hz, with a deformation amplitude sweep from 0.1% to 50% (outward cycle) and then from 50% to 0.1% (return cycle), at a given temperature, for example equal to 60° C., is recorded. These dynamic properties are thus measured for a frequency equal to 10 Hz, a deformation equal to 50% of the peak-to-peak deformation amplitude, and a temperature that may be equal to 60° C.

With respect to cracking, an elastomeric compound may be characterized, under static conditions, by a uniaxial tensile test, on a standardized test specimen, making it possible to determine its elongation at break, and also its tensile strength, at a given temperature, for example at 60° C.

An elastomeric compound can also be characterized in terms of its crack resistance, by a fatigue test. The fatigue strength N_{R}, expressed as number of cycles or in relative units, is measured in a known manner on 12 test specimens subjected to repeated low-frequency tensile deformations up to an elongation of 75%, at a temperature of 23° C., using a Monsanto (MFTR type) machine until the test specimen breaks, according to the ASTM D4482-85 and ISO 6943 standards. In the case of results expressed in relative units, a value greater than that of a control taken as a reference, arbitrarily set at 100, indicates an improved result, that is to say a better fatigue strength of the samples of elastomeric compound. Correspondingly, a value lower than 100 indicates an inferior result, that is to say less good fatigue strength of the samples of elastomeric compound.

An elastomeric compound may also be characterized, with respect to its crack resistance, by the rate of propagation of a crack in said elastomeric compound or crack rate, for a given elastic energy release rate.

The elastic energy release rate is the energy dissipated per unit surface area created by the crack when it propagates. It is expressed in joules per square metre. The crack process of the elastomers is generally separated into two phases: the first phase during which a crack initiates, then a second phase during which it propagates. Within the context of the invention, the inventors focused on the propagation phase of cracks in elastomeric compounds, by studying the relationships between the energy release rate, the rate of crack propagation, and the composition of the elastomer compounds.

The crack rate may be measured on test specimens of elastomeric compositions using a cyclic fatigue machine (Elastomer Test System) of the 381 type from MTS, as explained below. The crack resistance is measured using repeated tensile deformations on a test specimen initially accommodated (after a first tensile cycle) and then notched. The tensile test specimen is composed of a rubber slab of parallelepipedal shape, for example with a thickness between 1 and 2 mm, with a length between 130 and 170 mm and with a width between 10 and 15 mm, the two side edges each being covered in the direction of the length with a cylindrical rubber bead (diameter 5 mm) enabling anchoring in the jaws of the tensile testing machine. The test specimens thus prepared are tested after aging for 30 days at 80° C. under nitrogen. The test was carried out in atmospheric surroundings, at a temperature of 80° C. After accommodation, 3 very fine notches with a length of between 15 and 20 mm are made using a razor blade, at mid-width and aligned in the length direction of the test specimen, one at each end and one at the centre of the latter, before starting the test. At each tensile cycle, the degree of strain of the test specimen is automatically adjusted so as to keep the energy release rate (amount of energy released during the progression of the crack) constant at a value of less than or equal to approximately 900 J/m². The rate of crack propagation is the derivative of the cracked length relative to the number of cycles. It is measured in nanometres per cycle. For ease of reading, it is often expressed in relative units (r.u.) by dividing the rate of crack propagation in the control elastomeric compound by that in the elastomeric compound tested, the crack propagation rates being measured for the same energy release rate.

Regarding the crack mechanism, a person skilled in the art was able to observe the main steps of the propagation of a crack on a pre-notched test specimen subjected to a uniaxial tensile test at constant pull rate. Firstly, the crack opens without propagating, until a millimetric notch-tip radius is obtained. Then the notch bifurcates and propagates not in the direction perpendicular to the tension, but along the direction of tension, over a few millimetres, with a slow propagation rate (of the order of a few mm/s), before stopping. It is this phenomenon which is referred to as crack rotation. The crack is then reinitiated at the notch tip and may then bifurcate again and propagate in the same way. The rotations occur on the two edges of the notch and in a relatively symmetrical manner.

The use of a tyre for a heavy vehicle of construction plant type is characterized by the tyre bearing high loads and running on tracks covered with stones of various sizes. When the vehicle is being driven along, the tyre, mounted on its rim, inflated and compressed under the load of the vehicle, is subjected to bending cycles, particularly in its sidewalls. The bending cycles cause stresses and strains, mainly shear and compressive stresses and strains, in the sidewalls which deform at small radii of curvature. Over time, the bending cycles are capable of initiating cracks on the outer face of the sidewalls. The cracks may also be initiated by external mechanical attacks taking into account the harsh driving environment of the tyre.

These cracks may propagate both at the surface and radially inwards. The propagation of cracks at the surface may give a degraded aesthetic appearance of which the user may be mindful. The propagation of cracks radially inwards, through the sidewall, may reach the carcass reinforcement and open onto the inner wall of the tyre, generating a rapid pressure loss of the tyre. This pressure loss then requires the replacement of the tyre.

Given the increase in productivity in mines, via the speed of transport or via the load transported, the tyres of construction plant vehicles are subjected to increasingly high mechanical stresses, which makes them even more sensitive to the propagation of cracks in the sidewalls, capable of leading to a degraded aesthetic appearance and a rapid pressure loss in extreme cases.

The inventors have set themselves the objective of controlling the direction of the propagation of cracks of the sidewalls of the tyre, by orienting them inwards, without however passing through the carcass reinforcement which would lead to a flattening of the tyre. This approach has the advantage of preserving the external appearance of the sidewalls by preventing chunking of material following the cracking.

This objective has been achieved by a tyre for a heavy vehicle of construction plant type, comprising:
two sidewalls connecting a tread to two beads,
each sidewall consisting of a laminate comprising at least first and second sidewall layers that are axially superposed and have a total thickness E,
the axially outermost first sidewall layer having a thickness E1 and consisting of a elastomeric compound M1,
the first elastomeric compound M1 having an elastic dynamic shear modulus G′1, a viscous shear modulus G″1, a dynamic loss tgδ1, a fatigue crack resistance characterized by a number of cycles to failure NR1 and a crack propagation tendency characterized by a crack propagation rate VP1,
the axially innermost second sidewall layer having a thickness E2 and consisting of a second elastomeric compound M2,
the second elastomeric compound M2 having an elastic dynamic shear modulus G′2, a viscous shear modulus G″2, a dynamic loss tgδ2, a fatigue crack resistance characterized by a number of cycles to failure NR2 and a crack propagation tendency characterized by a crack propagation rate VP2,
the thickness E1 of the axially outside first sidewall layer being at most equal to 0.9 times the total thickness E of the laminate,
the thickness E2 of the axially inside second sidewall layer being at least equal to the minimum value between 3 mm and 0.1 times the total thickness E of the laminate,
the first elastomeric compound M1 having a number of cycles to failure NR1 at least equal to 150 000 cycles,
the second elastomeric compound M2 has a number of cycles to failure NR2 at least equal to 300 000 cycles
and the VP1/VP2 ratio of the respective crack propagation rates of the first and second elastomeric compounds (M1, M2) being at least equal to 1.25.

The essential idea of the invention is to have an axially outermost first sidewall layer, in contact with the atmospheric air, having a relatively great thickness E1 at most equal to 0.9 times the total thickness E of the laminate, in which the crack propagation rate VP1 is relatively high, and an axially innermost second sidewall layer, in contact with the carcass reinforcement, having a relatively small thickness E2 at most equal to 0.1 times the total thickness E of the laminate, in which the crack propagation rate VP2 is relatively low.

The distribution of the two sidewall layers is carried out so that the sidewall layer which has the lowest hysteresis, characterized by the viscous shear modulus G″, has the greatest thickness and is positioned on the exterior side of the tyre, while retaining a minimum thickness of 3 mm for the inner second sidewall layer.

It should be noted that preferentially the sidewall is formed by a laminate comprising only two sidewall layers, but that a laminate of more than two layers can also be envisaged. The mechanisms disclosed in the present document are however described in the case of a two-layer laminate.

In other words, the elastomeric compound of the axially outside first sidewall layer is designed to have a lower resistance to crack propagation than that of the elastomeric compound of the axially inside second sidewall layer. Thus, a crack initiated on the axially outside face of the first sidewall layer propagates rapidly, through the thickness of the sidewall, axially towards the inside of the tyre, and not at the outer surface of the tyre sidewall. When this crack reaches the vicinity of the axially inside second sidewall layer, the crack propagates more slowly with one or more rotations of its direction of propagation: thus the cracking is slowed down and no longer propagates axially inwards in the direction of the carcass reinforcement, which avoids cracking of the carcass reinforcement that may then lead to a slow or rapid pressure loss of the tyre. The inventors have shown that a VP1/VP2 ratio of the respective crack propagation rates of the first and second elastomeric compounds (M1, M2) at least equal to 1.25 guaranteed a significant effect of the invention.

Thus this double sidewall layer design advantageously makes it possible both to limit the cracking of the sidewall at the surface, responsible for an appearance problem of the sidewall, and to prevent a crack capable of reaching the carcass reinforcement, responsible for a loss of airtightness.

It should be noted that the dynamic properties of the first and second elastomeric compounds (M1, M2), i.e. the elastic dynamic shear moduli (G′1, G′2), the viscous shear moduli (G′1, G″2) and the dynamic losses (tgδ₁, tgδ₂) are measured at frequency of 10 Hz and at a temperature of 60° C. Furthermore, the crack propagation rates (VP1, VP2) are expressed in nanometres per cycle and measured at 80° C. for an energy release rate equal to 900 J/m².

Advantageously, the elastic dynamic shear moduli (G′1, G′2) of the first and second elastomeric compounds (M1, M2) are substantially equal, which means that their respective values differ by at most 6%. This makes it possible to prevent elastic deformation differentials between the first and second sidewall layers and therefore enables a better mechanical behaviour of the laminate.

More advantageously, the ratio of the viscous shear moduli G″1/G″2 respectively of the compounds (M1, M2) is at most equal to 0.55.

It is known that the sidewall of the tyre functions mechanically to deformations imposed in the crack initiation zone. As a result, the thermal behaviour of the sidewall is controlled by the viscous shear moduli G″₁ and G″₂ of the two respective elastomeric compounds of the first and second sidewall layers. The inventors have been able to show that the thermal behaviour of the sidewall was satisfactory, typically with an average operating temperature not exceeding 70° C., when the condition relating to the ratio of the viscous shear moduli G″1/G″2 respectively of the compounds (M1, M2) was met, knowing that the first sidewall layer has the lowest viscous shear modulus G″1 is the one which the highest thickness E1.

According to a first embodiment of the elastomeric compound M1 of the first sidewall layer, the elastic dynamic shear modulus G′1 of the first elastomeric compound M1 is advantageously at least equal to 0.86 MPa.

According to a second embodiment of the elastomeric compound M1 of the first sidewall layer, the dynamic loss tgδ1 of the first elastomer compound M1 is advantageously at most equal to 0.15.

According to a first embodiment of the elastomeric compound M2 of the second sidewall layer, the elastic dynamic shear modulus G′2 of the second elastomeric M2 is advantageously at least equal to 0.91 MPa.

According to a second embodiment of the elastomeric compound M2 of the second sidewall layer, the dynamic loss tgδ2 of the second elastomeric compound M2 is advantageously at most equal to 0.210.

It should be noted that the sidewalls of tyres of construction plant type have a mass representing around 15% of the total mass of the tyre, and therefore a large relative mass, which has a very strong impact on the thermics of the tyre. It is therefore advantageous to reduce the hysteresis of the sidewalls, therefore the dynamic losses of the elastomeric compounds constituting same, in order to reduce the operating temperature inside the tyre to prolong its endurance and therefore its service life. Thus, the elastomeric compound of the axially outside first sidewall layer is preferably designed to have a dynamic loss tgδ1 at least 55% lower than the dynamic loss tgδ2 of the elastomeric compound of the axially inside second sidewall layer. However, this drop in the hysteresis should be able to be achieved without adversely affecting the other properties of the elastomeric compounds of the sidewall, in particular mechanical properties such as the fatigue strength and more particularly the crack resistance. Specifically, the sidewalls of construction plant tyres are subjected to very high stresses, simultaneously in terms of flexural deformation, attack and thermal stresses.

In the sidewalls zone of the tyre, the inventors have demonstrated a correlation between the parameters relating to the crack propagation such as the energy released rate and the crack propagation rate, and the compositions of the elastomeric compounds. In particular, a link between the presence of rotations and the improvement in the properties of resistance to crack propagation has been established. The inventors put forward the hypothesis of a strong dependence of the crack propagation with, inter alia, the filler content of the composition of the elastomeric compound which should be greater than the percolation threshold of the elastomer, and with the bridge density of the elastomer.

Furthermore, prolonged static or dynamic stresses of the sidewalls in the presence of ozone cause more or less pronounced crazing or cracks to appear, the propagation of which under the effect of the persistence of the stresses may give rise to significant damage of the sidewall concerned. It is therefore also important for the compositions constituting the sidewalls of construction plant tyres in particular to have very good mechanical properties, and therefore generally a high content of reinforcing filler.

According to one preferred embodiment, the first elastomeric compound M1 is a rubber composition based at least on a mixture of polyisoprene and polybutadiene, a crosslinking system, a reinforcing filler comprising carbon black, the content of which varies from 30 to 40 phr (parts by weight per hundred parts of elastomer), and the BET surface area of which is greater than or equal to 110 m²/g which corresponds to that of the carbon black N220, in accordance with the ASTM classification.

According to another preferred embodiment, the second elastomeric compound M2 is a rubber composition based at least on a mixture of polyisoprene and polybutadiene, a crosslinking system, a reinforcing filler comprising carbon black N330, characterized by a BET surface area equivalent to 80 m²/g, the content of which varies from 40 to 60 phr, while remaining greater than the black content of the first elastomeric compound M1.

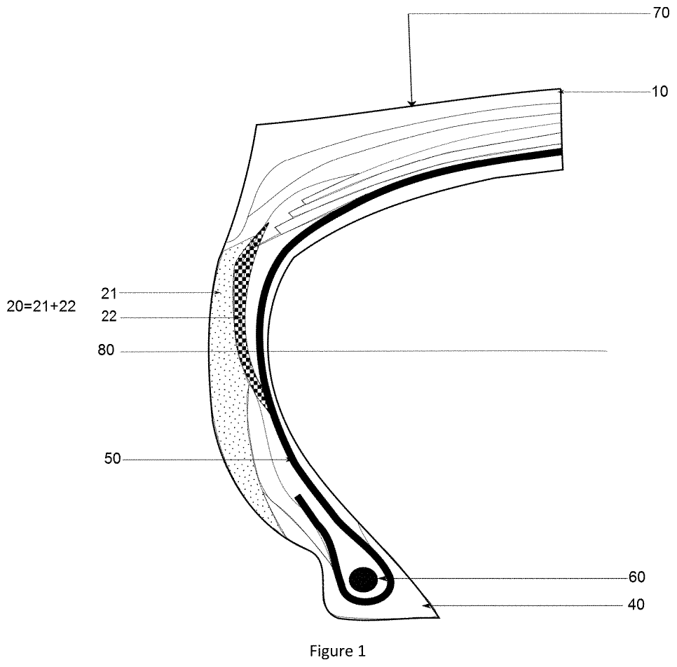

The architecture of a tyre sidewall according to the invention will be better understood with reference to FIG. 1, not to scale, which represents a meridian half section of a tyre according to the invention.

FIG. 1 schematically represents a tyre 10 intended to be used on Dumper type vehicles. The tyre 10 comprises a radial carcass reinforcement 50, anchored in two beads 40 and turned up, in each bead, around a bead wire 60. The carcass reinforcement 50 is formed of a layer of metal cords coated in an elastomeric compound. Positioned radially on the outside of the carcass reinforcement 50 is a crown reinforcement (not referenced), itself radially on the inside of a tread 70. Each sidewall 20 of the tyre connects the tread to the beads.

The thicknesses E1 and E2 respectively of the first and second sidewall layers 21 and 22, constituting the sidewall 20, are measured in the direction normal to the carcass reinforcement 50. The measurement points correspond to the positions determined by the intersections of the axis 80 with the faces of said sidewall layers.

According to the invention, each sidewall 20 is a laminate composed of two sidewall layers (21, 22) that are superimposed, at least partially, in the meridian plane. The axially outermost first sidewall layer 21 has a thickness E1 at most equal to 0.9 times the total thickness E of the laminate. The axially inside second sidewall layer 22 has a thickness E2 equal to the minimum value between 3 mm and 0.1 times the total thickness E of the laminate. The second axially inside sidewall layer 22 is in contact with the elastomeric coating compound of the carcass reinforcement, typically over at least 10 mm. The superposition of the two sidewall layers spreads out on either side of the axis 80 passing the axially outermost point of the sidewall and parallel to the axis of the tyre.

The invention has been more particularly studied on a tyre of 29R25 size, by comparison between two versions A and B of the tyre. The tyre A, a reference tyre, comprises a sidewall consisting of a single sidewall layer. The tyre B, according to one embodiment of the invention, comprises a sidewall consisting of two sidewall layers.

The sidewall of tyre A consists of an elastomeric compound M0 which is considered as the reference material. This reference elastomeric compound M0 of the single sidewall layer of the tyre A is identical to the second elastomeric compound M2 of the second sidewall layer of the tyre B.

Table 1 below gives an example of chemical compositions of the first and second elastomeric compounds M1 and M2 respectively constituting the first and second sidewall layers of a tyre B according to the invention:

TABLE 1

| | First elastomeric | Second elastomeric |
|---|---|---|
| | compound M1 of first | compound M2 of second |
| Composition | sidewall layer | sidewall layer |
| NR (Natural Rubber) | 50 | 50 |
| BR (Butadiene | 50 | 50 |
| Rubber) | | |
| Carbon black N330 | 0 | 55 |
| Carbon black N220 | 38 | 0 |
| Plasticizer | 10 | 18 |
| Wax | 1 | 1 |
| Antioxidant | 3 | 3 |
| ZnO | 2.5 | 2.5 |
| Stearic acid | 1 | 1 |
| Sulfur | 1 | 0.9 |
| Accelerator | 0.8 | 0.6 |

The first elastomeric compound M1 of the radially outside first sidewall layer differs from the second (reference) elastomeric compound M2 of the radially inside second sidewall layer by:
The fineness of its filler, characterized by the BET surface area defined in the standard ASTM D1765: The first elastomeric compound M1 is filled with carbon black N220 finer than the carbon black N330 of the second elastomeric compound M2;
The filler content, expressed in phr (per hundred of elastomer): The first elastomeric compound M1 has a filler content, equal to 38, lower than the filler content of the second elastomeric compound M2, equal to 55, taken as a reference;
The plasticizer content, which practically ranges from single to double between the first and second elastomeric compounds M1 and M2 respectively.

The first and second elastomeric compounds M1 and M2 were characterized mechanically, according to the methods described in the preamble. Table 2 below presents the mechanical characteristics thus determined:

TABLE 2

| | First elastomeric | | Second elastomeric | |
|---|---|---|---|---|
| Mechanical | compound M1 of first | | compound M2 of second | |
| characteristics | sidewall layer | | sidewall layer | |
| Elongation at break | 762% | | 780% | |
| (60° C.) | | | | |
| Tensile strength (60° | 11.9 | MPa | 12.1 | MPa |
| C.) | | | | |
| Number of fatigue | 150 000 | cycles | 300 000 | cycles |
| cycles to failure NR | | | | |
| (23° C.) | | | | |
| Crack rate VP (60° C., | 20 | nm/cycles | 9 | nm/cycles |
| 900 J/m²) ⁽¹⁾ | | | | |
| Elastic shear modulus | 0.86 | MPa | 0.91 | MPa |
| G′ (50%, 60° C. and | | | | |
| 10 Hz) ⁽²⁾ | | | | |
| Viscous shear modulus | 0.165 | MPa | 0.300 | MPa |
| G″ (50%, 60° C. and | | | | |
| 10 Hz) ⁽²⁾ | | | | |

| | | |
|---|---|---|
| Dynamic loss tgδ | 0.150 | 0.210 |
| (50%, 60° C. and | | |
| 10 Hz) ⁽²⁾ | | |

1) The crack propagation rates are measured with an accuracy of ±5 nm per cycle.
2) The mechanical characteristics G′, G″, and tgδ are measured on the return curve at 50% strain for the quantity G*, whereas for G″, and tgδ, these are the highest values obtained over the whole of the return cycle.

In a dynamic tensile test as described in the preamble of the description, on a pre-notched test specimen, the crack in the first elastomeric compound M1 propagates at a propagation rate around twice that observed in the second elastomeric compound M2. In contrast, in the second elastomeric compound M2, the appearance of rotations of the crack slows the progression of the crack. As described above, these properties are sought to promote the propagation of the crack in the axially outside first sidewall layer without leaving visible traces on the outside of the tyre. The propagation continues in the axially inside second sidewall layer without causing the flattening of the tyre following a loss of airtightness.

The inventors have experimentally determined that, in the sidewall zone of the tyre, an energy release rate at 900 J/m² is representative of the energy to be supplied in order to observe the evolution of the crack. For this energy release rate value, the same crack mechanism is observed, on a tyre after rolling, as that observed on a test sample.

The calculation of the temperature field by the finite element method shows a more favourable thermal environment for the tyre according to the invention. The average temperature in the sidewall of the reference tyre A is 80° C., whereas, for the tyre B according to the invention, the average temperature in the sidewall only rises to 70° C.

The inventors have furthermore carried out endurance tests on the tyres A and B. These tests are similar to those required, for example, by the European regulation UNECE/R54 for endurance, but adapted for tyres for construction plant vehicles. According to this test, the tyre B according to the invention has a 30% longer service life compared to the reference.

In these same tests, the cracks analysed after the end of the rolling of the tyres, confirm the crack propagation directions: initiation and propagation in the axially outside first sidewall layer, axially towards the inside of the tyre, then rotation after penetration into the axially inside second sidewall layer thus preventing the flattening of the tyre.

1.-9. (canceled)

10. A tire for a heavy vehicle of construction plant type comprising:
two sidewalls connecting a tread to two beads, each sidewall consisting of a laminate comprising at least first and second layers that are axially superposed and have a total thickness E, and the at least first and second layers comprising an axially outermost first sidewall layer and an axially innermost second sidewall layer,
wherein the axially outermost first sidewall layer has a thickness E1 and consists of a first elastomeric compound M1, the first elastomeric compound M1 having an elastic dynamic shear modulus G′1, a viscous shear modulus G″1, a dynamic loss tgδ1, a fatigue crack resistance characterized by a number of cycles to failure NR1 and a crack propagation tendency characterized by a crack propagation rate VP1,
wherein the axially innermost second sidewall layer has a thickness E2 and consists of a second elastomeric compound M2, the second elastomeric compound M2 having an elastic dynamic shear modulus G′2, a viscous shear modulus G″2, a dynamic loss tgδ2, a fatigue crack resistance characterized by a number of cycles to failure NR2 and a crack propagation tendency characterized by a crack propagation rate VP2,
wherein the thickness E1 of the axially outermost first sidewall layer is at most equal to 0.9 times the total thickness E of the laminate, the thickness E2 of the axially innermost second sidewall layer is at least equal to the minimum value between 3 mm and 0.1 times the total thickness E of the laminate, the first elastomeric compound M1 has a number of cycles to failure NR1 at least equal to 150,000 cycles, the second elastomeric compound M2 has a number of cycles to failure NR2 at least equal to 300,000 cycles, and a VP1/VP2 ratio of the crack propagation rates respectively in the first and second elastomeric compounds is at least equal to 1.25.

11. The tire according to claim 10, wherein the elastic dynamic shear moduli of the first and second elastomeric compounds are substantially equal.

12. The tire according to claim 10, wherein the ratio of the viscous shear moduli G″1/G″2 respectively of the first and second elastomeric compounds is at most equal to 0.55.

13. The tire according to claim 10, wherein the elastic dynamic shear modulus G′1 of the first elastomeric compound M1 is at least equal to 0.86 MPa.

14. The tire according to claim 10, wherein the dynamic loss tgδ1 of the first elastomeric compound M1 is at most equal to 0.15.

15. The tire according to claim 10, wherein the elastic dynamic shear modulus G′2 of the second elastomeric compound M2 is at least equal to 0.91 MPa.

16. The tire according to claim 10, wherein the dynamic loss tgδ2 of the second elastomeric compound M2 is at most equal to 0.210.

17. The tire according to claim 10, wherein the first elastomeric compound M1 is a rubber composition based at least on a mixture of polyisoprene and polybutadiene, a crosslinking system, a reinforcing filler comprising carbon black, the content of which varies from 30 to 40 phr (parts by weight per hundred parts of elastomer), and the BET surface area of which is greater than or equal to 110 m²/g which corresponds to that of the carbon black N220.

18. The tire according to claim 17, wherein the second elastomeric compound M2 is a rubber composition based at least on a mixture of polyisoprene and polybutadiene, a crosslinking system, a reinforcing filler comprising carbon black N330, characterized by a BET surface area equivalent to 80 m²/g, the content of which varies from 40 to 60 phr, while remaining greater than the carbon black content of the first elastomeric compound M1.
